(19) United States
(12) Patent Application Publication
(10) Pub. No.: US 2025/0128422 A1
(43) Pub. Date: Apr. 24, 2025

(54) ROBOT SYSTEM AND IMAGE CAPTURING METHOD

(71) Applicant: Fanuc Corporation, Yamanashi (JP)

(72) Inventor: Takashi Yamazaki, Minamitsuru-gun, Yamanashi (JP)

(73) Assignee: Fanuc Corporation, Yamanashi (JP)

(21) Appl. No.: 18/719,334

(22) PCT Filed: Dec. 21, 2021
(86) PCT No.: PCT/JP2021/047402

§ 371 Date: Jun. 13, 2024

(51) Int. Cl. B25J 9/16; H04N 23/62; H04N 23/667; H04N 23/67

(52) U.S. Cl. CPC B25J 9/1697; H04N 23/62; H04N 23/667; H04N 23/675

(57) ABSTRACT

A robot system includes a camera with an auto-focus lens, and a robot for performing work on the basis of an image capturing result of the camera, and can set a plurality of programs for using the camera. The robot system further includes a user interface that can set a focus position of the auto-focus lens in each of the programs, and a storage unit that stores focus values set in each of the plurality of programs. The user interface is configured to be able to execute, during execution of a program, a first image capture mode for performing image capturing using an auto-focus function of the auto-focus lens, and a second image capture mode for performing image capturing using the focus value stored in the storage unit, without using the auto-focus function.

### CROSS REFERENCES TO RELATED APPLICATIONS

This is the U.S. National Phase application of PCT/JP2021/047402, filed Dec. 21, 2021, the disclosure of which being incorporated herein by reference in it entirety for all purposes.

### FIELD OF THE INVENTION

The present invention relates to a robot system having a user interface for capturing an object with an autofocus camera, and a capturing method using the interface.

### BACKGROUND OF THE INVENTION

A system is well known in which a detection process is performed on an image obtained by capturing an object with a camera, and a robot is operated based on the detection result. In the prior art, it is usual that a camera used in such a system is provided with a (manual focus) lens whose focus is manually adjusted, but in recent years, as a result of improvements in autofocus technology and lower prices, an (autofocus) lens whose focus can be automatically adjusted is increasingly being used.

For example, a technique is known in which a CCD camera with an autofocus function captures an image of a person, determines the distance between a robot and the person, and the motion of the robot is controlled (e.g., see Patent Literature 1). Further, a technique is known in which an imaging unit having an autofocus mechanism is mounted on a robot arm, the imaging unit is used to image an object, and the robot is controlled, based on the obtained image (e.g., see Patent Literature 2).

### PATENT LITERATURE

[PTL 1] JP 2002-219676 A
[PTL 2] JP 2019-125056 A

### SUMMARY OF THE INVENTION

Using a camera with an autofocus lens has advantages such as being able to obtain a reasonably appropriate image even if the operator does not have specialized knowledge, and not having to manually adjust the focus of the lens. On the other hand, in imaging using autofocus, even if the position and posture of the imaging target relative to the camera are exactly the same, the automatically adjusted focus position (focal length) may differ, depending on conditions such as lighting. Therefore, the focus position obtained by autofocus may differ between when, for example, a detection program is taught and when the taught detection program is applied to a production site. In such cases, at the production site, the taught detection program is executed to perform detection processing on images captured with a focus different from that at the time of teaching, which may result in the desired detection accuracy not being obtained.

Further, even when there is no problem with the accuracy of focus adjustment, focus adjustment requires a certain amount of time, and thus performing focus adjustment while a production line is operating at a production site will lead to an increase in the takt time of the robot system.

One aspect of the present disclosure is a robot system including a camera with an autofocus lens and a robot configured to perform an operation based on a capturing result of the camera, the robot system being configured to set a plurality of programs for using the camera, the robot system comprising: a user interface configured to set a focus position of the autofocus lens in each of the programs; and a storage unit configured to store a focus value which is set in each of the plurality of programs, wherein the user interface is configured to execute, during execution of the program, a first capture mode for performing image capturing using an autofocus function of the autofocus lens, and a second capture mode for performing image capturing using the focus value stored in the storage unit, without using the autofocus function.

Another aspect of the present disclosure is a capturing method performed in a robot system including a camera with an autofocus lens and a robot configured to perform an operation based on a capturing result of the camera, the robot system being configured to set a plurality of programs for using the camera, the capturing method comprising the steps of: setting a focus position of the autofocus lens in each of the programs; storing a focus value which is set in each of the plurality of programs; and executing, during execution of the program, a first capture mode for performing image capturing using an autofocus function of the autofocus lens, and a second capture mode for performing image capturing using the stored focus value, without using the autofocus function.

According to the present disclosure, manual focus adjustment becomes unnecessary, and variations in focus position which may occur when using the program for capturing with the autofocus camera under different conditions can be eliminated or reduced. Furthermore, by using the second capture mode which does not use the autofocus function, the focusing operations of the camera can be reduced, whereby the life of the camera can be extended.

### BRIEF DESCRIPTION OF DRAWINGS

FIG. 1 is a schematic view of a robot system according to an embodiment.

FIG. 2 is a view showing an example of setting a capture program using a user interface.

FIG. 3 is a view showing another example of setting a capture program using the user interface.

FIG. 4 is a view showing an example of setting a different focus value in the example of FIG. 3.

FIG. 5 is a flowchart showing an example of a process with respect to the capture program.

### DETAILED DESCRIPTION OF EMBODIMENTS OF THE INVENTION

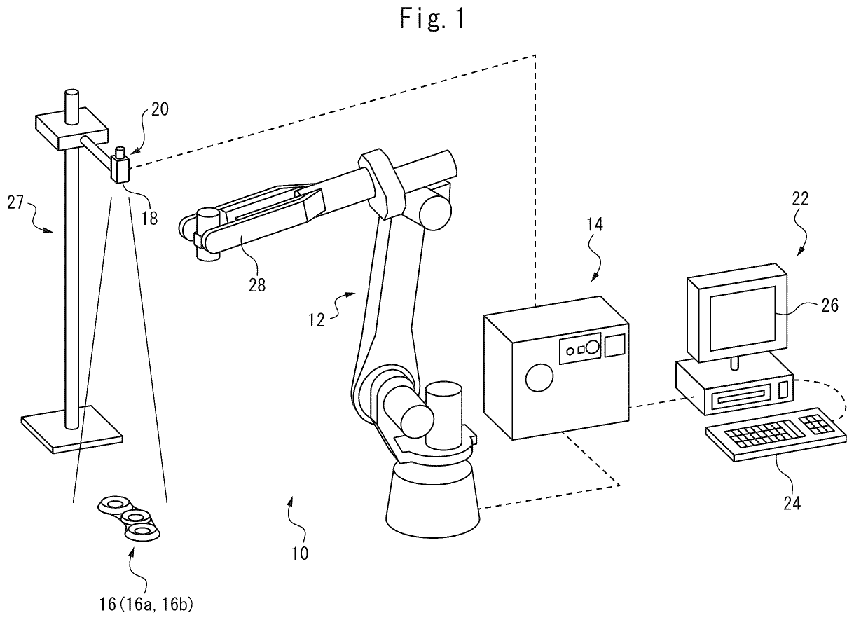

FIG. 1 is a schematic diagram of a robot system according to a preferred embodiment. A robot system 10 includes at least one robot 12, a robot controller 14 configured to control the robot 12, and a camera 20 having an autofocus lens 18 for capturing an object (workpiece) 16 to be detected. The robot 12, the controller 14 and the camera 20 are communicably connected to each other by wire or wirelessly.

The robot 12 is, for example, an articulated industrial robot, and is configured to perform various operations such as processing and/or a picking up the workpiece, based on a capturing result of the workpiece 16 as described below. The robot controller 14 includes a processor and a storage unit (memory), etc., and is configured to control the camera 20, based on a prepared detection program, and to adjust a focus of the lens 18 when capturing the workpiece 16.

The robot controller 14 may store and execute the above detection program, as well as a robot program for controlling the robot 12. Alternatively, the detection program may be stored in a computing machine such as a personal computer (PC) 22 having a processor and a storage unit (memory), which is connected to the controller 14 or the camera 20 by wire or wirelessly, so that the PC 22 may control the camera 20. At least one of the controller 14 and the PC 22 has an input unit such as a keyboard 24 or a touch panel, and a display unit such as a display 26. The input unit and the display unit constitute a user interface as described below.

In the example of FIG. 1, the camera 20 is fixed and supported by a pedestal 27, etc., which is independent from the robot 12. Such a configuration is suitable, for example, when the workpiece 16 is transported by a conveyor (not shown), etc., so that the workpiece 16 always passes through a field of view of the camera. Alternatively, the camera 20 may be arranged on a movable part such as a robot arm 28 of the robot 12. Such a configuration is suitable, for example, when the workpiece is relatively large and it is desirable to move the camera in order to capture different portions of the workpiece.

### First Example

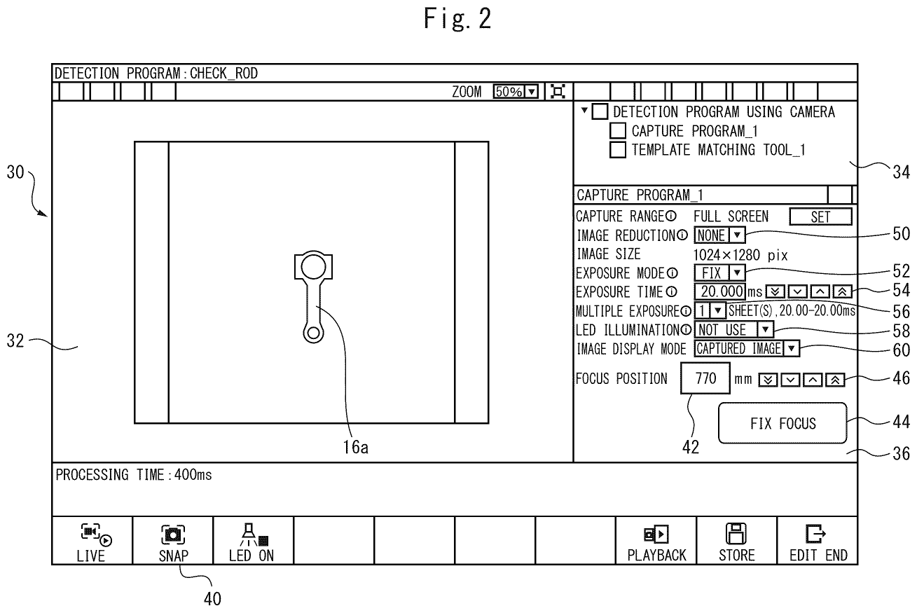

FIG. 2 show an example of a user interface used when a workpiece 16 having a connection rod shape is captured by the camera 20. Reference numeral 30 represents a teaching screen displayed on display 26 of the controller 14 or the PC 22. In this example, the teaching screen 30 is a user interface for performing settings related to capturing the workpiece, and parameter settings for the detection program which uses the image of the workpiece, etc. The teaching screen 30 includes an image display area 32 of the captured workpiece, a tree area 34 which displays a configuration tree of a tool included in the detection program, and a setting area 36 of a tool selected as a setting target in the configuration tree. In this example, as shown in the tree area 34, the detection program using the camera 20 includes a capture program_1 for capturing the workpiece 16a using the camera 20, and a template matching tool_1 configured to match an image of the workpiece 16a acquired by executing the capture program_1 with a previously prepared template.

Next, a procedure for capturing the workpiece using the user interface will be explained. First, when an operator operates (e.g., touches or presses) a capture button 40 during teaching of the robot 12, the camera 20 captures the workpiece 16a, as shown in FIG. 1. This capturing is normally performed using the autofocus function of the camera 20, but when the focus is fixed, the capturing can also be performed with the fixed focus. The method of capturing the workpiece using the autofocus function of the camera 20 in this manner is also referred to as a first capture mode.

The focus position (the distance between the camera 20 and the workpiece 16a) automatically adjusted and set by the autofocus function is displayed on a focus position display section 42 within the setting area 36. Alternatively, the focus position display section 42 may display the focus position used in the past (e.g., immediately previous) capturing.

When the image of the workpiece 16a, which is captured at the focus position (770 mm in this case) displayed on the focus position display section 42 and displayed on the display area 32, is determined to be appropriate, the operator operates (e.g., touches or presses) a focus fixing button 44 so that the focus position is fixed (or stored in the storage unit of the controller 14 or the PC 22). Alternatively, when the image of the workpiece 16a is not appropriate (for example, when it is clearly out of focus and unclear, or when it is judged to be inappropriate for performing the above-mentioned template matching, even if it is somewhat clear), the operator corrects the focus position by which an appropriate image can be provided, via the user interface (specifically, by operating a focus position adjustment button 46), and then operates the focus fixing button 44 to save the focus position.

In this manner, in the robot teaching stage, etc., the first capture mode completes the storage (fixation) of the focus position in one detection program. Next, when moving and applying the robot system 10 to a production site such as a production line and capturing an image of the workpiece 16a with the camera 20 as in the teaching stage, the autofocus function of the camera 20 is not used and the workpiece 16a is captured using the fixed focus position in the first capture mode. In this regard, the relative positional relationship between the camera 20 and the workpiece 16a (i.e., the position and posture of the workpiece 16a relative to the camera 20) is the same in the teaching stage and the production stage. The method of capturing the workpiece using the focus value stored in the first capture mode without using the autofocus function of the camera 20 is also referred to as a second capture mode.

In the user interface shown in FIG. 2, various settings can be made, as well as displaying and fixing (saving) the focus position. For example, as shown in the setting area 36, regarding the execution of the capture program, setting whether to reduce the image (reference numeral 50), setting an exposure mode (fixed or automatic adjustment) (reference numeral 52), setting an exposure time (reference numeral 54), setting the number of multiple exposures (reference numeral 56), setting whether to use LED lighting (reference numeral 58), and setting image display mode (whether to display only the captured image or to display the detection result and teaching model superimposed on the captured image) (reference numeral 60), can be performed.

In the example of FIG. 2, as shown in the tree area 34, the detection program includes the capture program and a matching tool, and the focus position is set and stored in the capture program. However, the present disclosure is not limited as such. For example, when the capture program and the detection program are prepared separately and included in the teaching program of the robot, the focus position may be stored or set in the detection program or in a program part of the teaching program other than the capture program and the detection program. In this manner, in the present disclosure, the program for using the camera is not limited to the capture program.

### Second Example

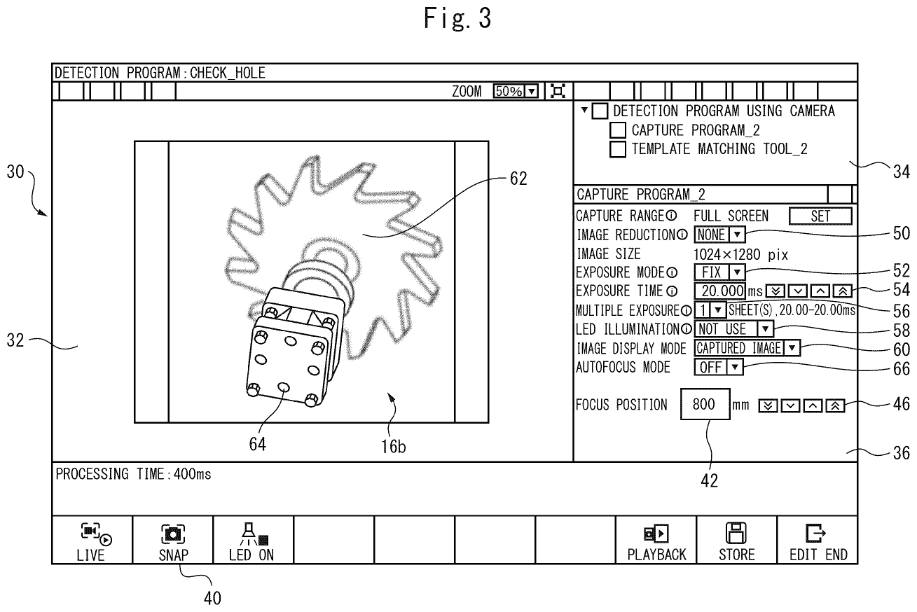

FIG. 3 shows an example of a user interface used when the camera 20 is used to image a workpiece 16b constituted from a gear-shaped rotary cutter 62 and a flange 64 for supporting the rotary cutter 62. In the second example, parts which are different from the first example are mainly explained, and the other parts which may be the same as the first example are given the same reference numerals as those in the first example, and detailed explanation thereof will be omitted.

In this example, as shown in the tree area 34, the detection program using the camera 20 includes a capture program_2 for capturing the workpiece 16b using the camera 20, and a template matching tool_2 configured to match an image of the workpiece 16b acquired by executing the capture program_2 with a previously prepared template.

Next, the procedure for capturing the workpiece using the user interface is explained. First, when the operator operates e.g., touches or presses) the capture button 40 during teaching of the robot 12, the camera 20 captures an image of the workpiece 16b, as shown in FIG. 1. In this regard, in the second example, it is assumed that it is necessary to capture and detect a plurality of different portions of the workpiece 16b, and a flange 64 (in particular, a hole formed in the flange 64) should be captured in the first capture mode (or by the autofocus function), as shown in FIG. 3. Whether or not to use the autofocus function can be set, for example, by operating an autofocus setting button 66 in the setting area 36. In the image of the workpiece 16b obtained in this way, as shown in the display area 32, the flange 64 is in focus. On the other hand, the image of the rotary cutter 62, whose distance from the camera 20 is significantly different from the flange 64 is in focus, is out of focus and becomes slightly blurred.

The focus position (the distance between the camera 20 and the flange 64), which is automatically adjusted and set by the autofocus function, is displayed on the focus position display section 42 within the setting area 36. Alternatively, the focus position display section 42 may display the focus position used in the past (e.g., immediately before) capturing.

When the image of the workpiece 16b, which is captured at the focus position (800 mm in this case) displayed on the focus position display section 42 and displayed on the display area 32, is determined to be appropriate, the operator operates (e.g., touches or presses) the focus fixing button 44, so that the focus position is fixed (or stored in the storage unit of the controller 14 or the PC 22). Alternatively, when the image of the workpiece 16b is not appropriate (for example, when it is clearly out of focus and unclear, or when it is judged to be inappropriate for performing the above-mentioned template matching, even if it is somewhat clear), the operator corrects the focus position by which an appropriate image can be provided, by operating the focus position adjustment button 46, and then operates the focus fixing button 44 to save the focus position.

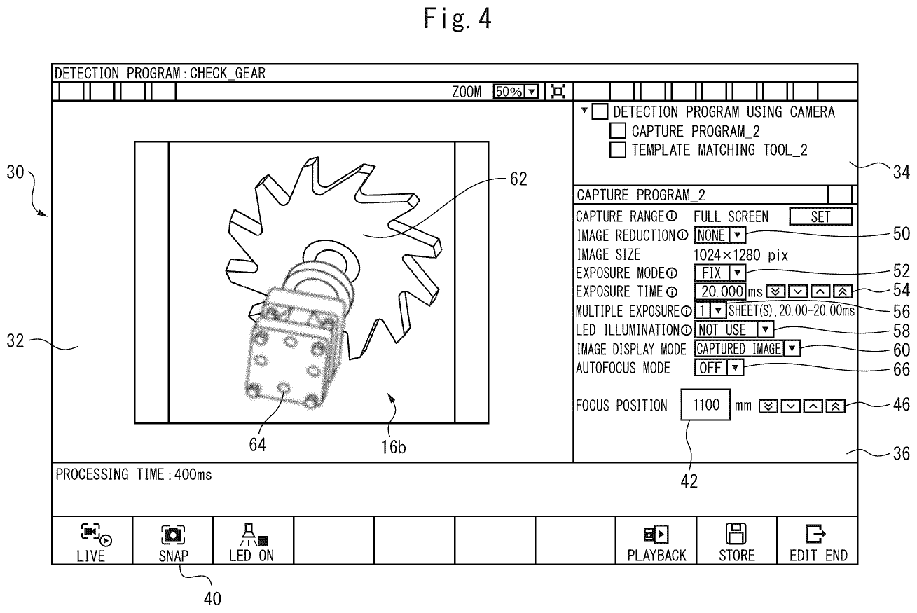

Next, as shown in FIG. 4, the rotary cutter 62 is captured in the first capture mode (or by the autofocus function). Whether or not to use the autofocus function can be determined, for example, by operating the autofocus setting button 66 in the setting area 36. In the image of the workpiece 16b obtained in this way, as shown in the display area 32, the rotary cutter 62 is in focus, and the flange 64 is out of focus and becomes slightly blurred.

The focus position (distance between the camera 20 and the rotary cutter 62), which is automatically adjusted and set by the autofocus function, is displayed on the focus position display section 42 within the setting area 36. Alternatively, the focus position display section 42 may display the focus position used in the past (e.g., immediately before) capturing.

When the image of the workpiece 16b, which is captured at the focus position (1100 mm in this case) displayed on the focus position display section 42 and displayed on the display area 32, is determined to be appropriate, the operator operates the focus fixing button 44 (e.g., touches or presses), so that the focus position is fixed (or stored in the storage unit of the controller 14 or the PC 22). Alternatively, when the image of the workpiece 16b is not appropriate (for example, when it is clearly out of focus and unclear, or when it is judged to be inappropriate for performing the above-mentioned template matching, even if it is somewhat clear), the operator corrects the focus position by which an appropriate image can be provided, by operating the focus position adjustment button 46, and then operates the focus fixing button 44 to save the focus position.

As described above, in FIGS. 3 and 4, the focus positions obtained by the autofocus function are different, and the focus positions are stored for each. In other words, in the second example, even when the workpiece is the same, the captured portions are different and the focus positions also differ accordingly, and thus the respective detection programs are treated also as different. In this way, even when the object (workpiece) to be captured is the same, the optimal focus position will be different when the captured portion is different, and therefore it is preferable to prepare different detection programs and store and fix the focus position for each. Needless to say, when the captured objects are different as in the first and second examples, different detection programs are used.

In this manner, in the robot teaching stage, etc., the first capture mode completes the storage (fixation) of the focus position in each of the plurality of (in this case, two) detection programs. Next, when applying the robot system 10 to a production site such as a production line and capturing an image of the workpiece 16b with the camera 20 as in the teaching stage, the autofocus function of the camera 20 is not used and the workpiece 16b is captured using the fixed focus position in the first capture mode. Concretely, the rotary cutter 62 and the flange 64 are captured separately. In this regard, it is assumed that the relative positional relationship between the camera 20 and the workpiece 16b (the position and posture of the workpiece 16b relative to the camera 20) is the same in the teaching stage and the production stage. The method of capturing the workpiece using the focus value stored in the first capture mode without using the autofocus function of the camera 20 is also referred to as a second capture mode.

According to the above examples, even an operator who is not familiar with manual focus operations can easily perform teaching. Further, since the autofocus function is not used at the production site, the time required to adjust the focus position can be reduced, and the overall cycle time of the system can be shortened. In addition, since no focusing operation is performed at the production site, the number of times the focusing operation is performed is reduced compared to the case where the autofocus function is used both during teaching and during production line operation, whereby the life of the camera is extended. Furthermore, with autofocus, even when the relative positional relationship between the camera and the workpiece is the same, the focus position may vary, depending on the detection process, especially at production sites, due to lighting conditions and disturbances (such as flying insects and foreign objects). However, the examples can also avoid such variations.

In the examples described above, the first capture mode is executed when teaching the robot, and the second capture mode is executed when the robot is applied to the production site, although the present disclosure is not limited thereto. For example, instead of the teaching at a location different from the production site, a simulation using the PC 22, etc., may be executed, and the first capture mode may be executed in the simulation so as to store the focus position. In the simulation, by inputting the positional relationship between the camera and the workpiece, etc., it is possible to calculate and display the image which would be obtained when the workpiece is actually captured by the camera. Therefore, the focus position can be set, adjusted and stored by the operations similar to the examples described above.

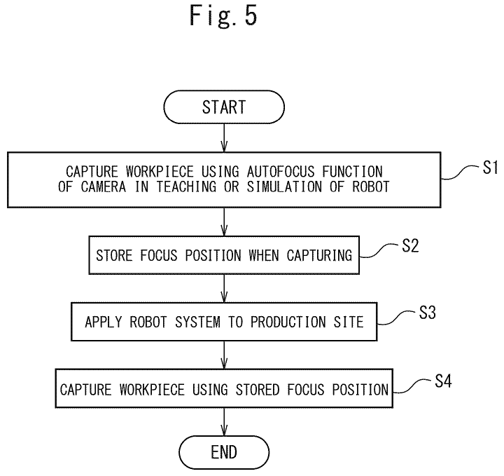

FIG. 5 is a flowchart showing the flow of processes in the above example. First, in step S1, the workpiece is captured by autofocus in the first capture mode (e.g., when teaching the robot). In the next step S2, the focus position when capturing the image using autofocus is stored. The focus position is stored for each detection program. In other words, different values for the focus position are set and stored for each detection program. In the next step S3, for example, when operating the robot at the production site, the workpiece is captured at the focus position stored in the first capture mode (e.g., during the teaching) without using the autofocus function when executing the detection program, as the second capture mode.

### REFERENCE SIGNS LIST

10 robot system
12 robot
14 robot controller
16, 16a, 16b workpiece
18 lens
20 camera
22 PC
24 input unit
26 display
27 pedestal
28 robot arm
30 teaching display
32 image display area
34 tree area
36 setting area
40 capture button
44 focus fixing button
46 focus position adjustment button
62 cutter
64 flange
66 autofocus mode setting unit

1. A robot system including a camera with an autofocus lens and a robot configured to perform an operation based on a capturing result of the camera, the robot system being configured to set a plurality of programs for using the camera, the robot system comprising:
a user interface configured to set a focus position of the autofocus lens in each of the programs; and
a storage unit configured to store a focus value which is set in each of the plurality of programs,
wherein the user interface is configured to execute, during execution of the program, a first capture mode for performing image capturing using an autofocus function of the autofocus lens, and a second capture mode for performing image capturing using the focus value stored in the storage unit, without using the autofocus function.

2. The robot system according to claim 1, wherein, in the first capture mode and the second capture mode, a relative positional relationship between the camera and an object to be imaged by the camera is the same.

3. The robot system according to claim 2, wherein the focus value stored in the storage unit is a focus value obtained by using the autofocus function in the first capture mode, or a focus value acquired by correcting the focus value obtained by using the autofocus function, by using the user interface.

4. The robot system according to claim 2, wherein the first capture mode is executed when the robot is taught, and the second capture mode is executed when the robot is used at a production site.

5. The robot system according to claim 1, wherein the program is prepared for different workpieces or different capturing regions of the same workpiece.

6. A capturing method performed in a robot system including a camera with an autofocus lens and a robot configured to perform an operation based on a capturing result of the camera, the robot system being configured to set a plurality of programs for using the camera, the capturing method comprising the steps of:
setting a focus position of the autofocus lens in each of the programs;
storing a focus value which is set in each of the plurality of programs; and
executing, during execution of the program, a first capture mode for performing image capturing using an autofocus function of the autofocus lens, and a second capture mode for performing image capturing using the stored focus value, without using the autofocus function.

7. The capturing method according to claim 6, wherein the first capture mode is executed when the robot is taught, and the second capture mode is executed when the robot is used at a production site.
